(19) United States
(12) Patent Application Publication
(10) Pub. No.: US 2026/0167113 A1
(43) Pub. Date: Jun. 18, 2026

(54) REMOVABLE CENTER CONSOLE FOR A MODIFIED VEHICLE

(71) Applicant: The Braun Corporation, Winamac, IN (US)

(72) Inventors: Michael T. Zindler, Kalamazoo, MI (US); James Stoner, Star City, IN (US); Bill Newton, Rochester, IN (US)

(73) Assignee: The Braun Corporation, Winamac, IN (US)

(21) Appl. No.: 19/385,223

(22) Filed: Nov. 11, 2025

Related U.S. Application Data
(60) Provisional application No. 63/734,823, filed on Dec. 17, 2024.

(51) Int. Cl. B60R 7/04

(52) U.S. Cl. CPC B60R 7/04

(57) ABSTRACT

A passenger vehicle is provided with a configurable interior designed to transport both ambulatory and wheelchaired passengers. The vehicle features easily removable and installable driver and front passenger seats, as well as a console that can be positioned between the seats or removed and stored, all without the use of tools. The configuration allows for the rapid transformation of the vehicle’s interior to accommodate a wheelchaired passenger by removing the seats and console and securing the wheelchair in their place with a wheelchair securement system. This versatile design ensures accessibility and convenience for various passenger needs.

### CROSS-REFERENCE TO OTHER APPLICATIONS

This application claims priority to U.S. Provisional Patent Application No. 63/734,823, filed on December 17, 2024, the contents of which are incorporated herein by reference.

### FIELD OF THE DISCLOSURE

The present disclosure relates generally to a passenger vehicle that has been modified to allow access by a physically limited passenger, and in one aspect providing a removable center console for a lowered-floor wheelchair accessible vehicle.

### BACKGROUND

Automobile manufacturers do not currently mass-produce passenger motor vehicles specifically designed to transport passengers having physical limitations, either as a driver or as a non-driving passenger. Consequently, mass-produced passenger motor vehicles are modified, or retrofitted, by aftermarket companies dedicated to supplying vehicles to physically limited passengers. Such vehicles can be modified by removing certain parts or structures within a vehicle and replacing those parts with parts specifically designed to accommodate the physically limited passenger. For example, in one configuration, a vehicle’s floor is removed and replaced with a lowered floor (sometimes referred to as a floor weldment) and a ramp to enable a physically limited individual using a wheelchair to enter and exit the vehicle without the assistance of another individual. Once inside the vehicle, such individuals may occupy the driver position and operate the vehicle as a vehicle operator or occupy locations designated for passengers. This may include, but is not limited to, a front passenger location or mid and rear passenger locations, one or both of which may be provided with a wheelchair securement system, such as a four-point tie down system (either manual belts or retractor belts, see for example the Q’Straint QRT series) or a docking system (see for example the Q’Straint QLK series).

With reference to FIGS. 1-4, lowering the floor 120 of a passenger motor vehicle 100 a distance D_{L} to accommodate an individual using a wheelchair requires the original equipment manufacturer (OEM) seating arrangement 110 to be removed. Other accessory structures mounted to the OEM floor must also be removed. For instance, many OEM vehicles, such as the Chevrolet Traverse, come with a center console 130 between the driver seat 112 and front passenger seat 114, where the center console 130 includes cup holders and storage bins. The console 130 is fixed (i.e., non-hand removable) and must be removed in the course of removing and lowering the vehicle floor 120.

Typically, the two OEM front seats 112, 114 are replaced or modified to include quick-release bases 117, 119 that allow them to be installed the modified vehicle 101 in the driver and front passenger positions for use by ambulatory passengers. The seat bases 117,119 include risers to account for the lowered floor 121 to keep a seated passenger’s line of vision at roughly the same height it was prior to the modification. Either or both of the modified front seats 113, 115 may be removed so the driver and/or front passenger positions may be occupied by wheelchaired passengers.

However, the OEM center console 130 is not replaced or modified for re-use, but rather is discarded. Wheelchair accessible vehicles do not typically include center consoles 130. Including a center console 130 between the driver and front passenger positions of a wheelchair accessible vehicle 101 would not provide sufficient space for a wheelchair, which is oftentimes wider than the OEM seat 112, 114.

What is needed therefore is a replacement, modified, or retrofitted center console that can be installed when both the driver and front passenger seats are being utilized and can be removed when one or both of the front passenger positions need to be utilized by a wheelchaired passenger.

### SUMMARY OF THE EMBODIMENTS

In one embodiment, there is disclosed a method for converting a passenger vehicle for wheelchair access, the method comprising the steps of: removing a seating arrangement from the passenger vehicle, wherein the seating arrangement comprises at least one ambulatory seat and a console; removing at least a portion of a floor of the passenger vehicle; installing a lowered floor; and providing a replacement console with a hand-releasable connection member for connecting the replacement console to the lowered floor.

In a development, the method further comprises a lowered floor installed in the passenger vehicle defining a front compartment area of the passenger vehicle.

In a development, the method further comprises a lowered floor defining a driver position and a front passenger position and the hand-releasable connection is configured to connect the console to the lowered floor between the driver position and the front passenger position.

In a development, the method further comprises at least one ambulatory seat comprising a driver seat and a front passenger seat.

In a development, the method further comprises the step of providing the at least one ambulatory seat with a hand-releasable connection member for connecting the at least one ambulatory seat to the lowered floor.

In a development, the method further comprises the steps of modifying the driver seat to be hand-releasably connected to the lowered floor in the driver position and modifying the front passenger seat to be hand-releasably connected to the lowered floor in the front passenger position.

In a development, the method further comprises the step of configuring the vehicle to transport a first ambulatory passenger and a second ambulatory passenger by: installing the driver seat in the driver position without using a tool; installing the front passenger seat in the passenger position without using a tool; and installing the replacement console between the driver seat and the front passenger seat without using a tool.

In a development, the method further comprises the step of configuring the vehicle to transport a wheelchaired passenger by: removing at least one of the driver seat and the front passenger seat without using a tool; and removing the replacement console without using a tool.

In a development, the method further comprises the step of providing the lowered floor with at least one track and wherein the hand-releasable connection member of the replacement console is a track fitting configured to lockingly engage the track.

In a development, the method further comprises a track being an L-type track and the track fitting is an L-track type stud fitting with a hand-tightening knob.

In a development, the method further comprises an at least one track comprising a set of two parallel tracks.

In a development, the method further comprises a set of two parallel tracks being longitudinally aligned in the passenger vehicle, whereby the replacement console is adjustably mountable in a fore direction and an aft direction.

In a development, the method further comprises the steps of providing the lowered floor with at least one striker bar and providing the replacement console with at least one rotary latch configured to lockingly engage the striker bar.

In a development, the method further comprises the step of providing the replacement console with a release lever coupled to the rotary latch for releasing the rotary latch from the striker bar.

In a development, the method further comprises the step of providing the replacement console with the rotary latch at a first end and with a hook at a second end, whereby the hook is configured to receive the first striker bar when the replacement console is in an inclined position and the rotary latch is configured to receive the second striker bar as the replacement console is pivoted downward from the inclined position.

In a development, the method further comprises the step of converting the console into the replacement console.

In a development, the method further comprises the step of providing the replacement console with an electronic control and an electric harness configured for coupling to the passenger vehicle.

In a development, the method further comprises the steps of providing the lowered floor with a first corresponding connection member in a console use location and providing the passenger vehicle with a second corresponding connection member in a console stow location, wherein the first corresponding connection member and the second corresponding connection member are configured to engage with the hand-releasable connection member of the replacement console.

In a development, the method further comprises a console use location being between the driver position and the front passenger position.

In a development, the method further comprises a console stow location being in a rear cargo area of the vehicle.

In another embodiment, there is disclosed a passenger vehicle configured for wheelchair access, the passenger vehicle comprising: a floor in a front compartment area of the vehicle; a driver seat and a front passenger seat, each comprising a hand-releasable connection member connected the floor; and a console with a hand-releasable connection member connecting the console to the floor between the driver seat and the front passenger seat.

In a development, the vehicle further comprises at least one track coupled to the floor, wherein the hand-releasable connection member of the console is a track fitting configured to lockingly engage the track.

In a development, the vehicle further comprises a track being an L-type track and the track fitting is an L-track type stud fitting with a hand-tightening knob.

In a development, the vehicle further comprises an at least one track comprising a set of two parallel tracks.

In a development, the vehicle further comprises a set of two parallel tracks being longitudinally aligned on the floor, whereby the console is adjustably mountable in a fore direction and an aft direction.

In a development, the vehicle further comprises at least one striker bar coupled to the floor, wherein the hand-releasable connection member of the console comprises at least one rotary latch lockingly engaged with the at least one striker bar.

In a development, the vehicle further comprises a console comprising a release lever coupled to the at least one rotary latch for releasing the at least one rotary latch from the at least one striker bar.

In a development, the vehicle further comprises a first striker bar and a second striker bar coupled to the floor, wherein the console comprises a rotary latch at a first end and a hook at a second end, whereby the hook is configured to receive the first striker bar when the console is in an inclined position relative to the floor and the rotary latch is configured to receive the second striker bar as the console is pivoted downward from the inclined position.

In a development, the vehicle further comprises a console comprising an electronic control coupled to the passenger vehicle by a hand-releasable electric harness.

In a development, the vehicle further comprises a first corresponding connection member coupled to the floor between the driver seat and the front passenger seat and a second corresponding connection member coupled to the passenger vehicle in a console stow location, wherein the first corresponding connection member and the second corresponding connection member are configured to engage with the hand-releasable connection member of the replacement console.

In a development, the vehicle further comprises a console stow location being in a rear cargo area of the vehicle.

In another embodiment, there is disclosed a method for using one or more of the modified vehicles of the present disclosure, the method comprising the step of configuring the vehicle to transport a first ambulatory passenger and a second ambulatory passenger by: installing the driver seat in a driver position without using a tool; installing the front passenger seat in a passenger position without using a tool; and installing the console between the driver seat and the front passenger seat without using a tool.

In another embodiment, there is disclosed a method for using a method for using one or more of the modified vehicles of the present disclosure, the method comprising the step of configuring the vehicle to transport a wheelchaired passenger by: removing at least one of the driver seat from a driver position and the front passenger seat from a front passenger position without using a tool; and removing the console without using a tool.

In a development, the method further comprises the step of securing the wheelchaired passenger in place of one of the driver seat and the front passenger using a wheelchair securement system.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of the front compartment area of a prior art OEM passenger vehicle.

FIG. 2 is a rear view of the front compartment area of FIG. 1.

FIG. 3 is a perspective view of a front compartment area of an OEM passenger vehicle that has been modified to accommodate a wheelchaired passenger.

FIG. 4 is a rear view of the front compartment area of FIG. 3.

FIG. 5 is a perspective view of the front compartment area of the modified passenger vehicle of FIG. 3 that has been further modified to include a first embodiment of a hand-removeable center console.

FIG. 6 is a rear view of the front compartment area of FIG. 5.

FIG. 7 is an exploded perspective view of the first embodiment of the hand-removeable center console of FIG. 5.

FIG. 8 is a perspective assembly view of the first embodiment of the hand-removeable center console of FIG. 5.

FIG. 9 is partial perspective of the front compartment area of FIG. 5 with the front seats removed.

FIG. 10 is a detail, exploded perspective view of the fastening system depicted in FIG. 9.

FIG. 11 is a perspective view of a second embodiment of a mounting frame for the hand-removeable center console of FIGS. 5-10.

FIG. 12 is a perspective view of a third embodiment of a mounting from for the hand-removeable center console of FIGS. 5-10.

FIG. 13 is a perspective view of a second embodiment of a cover for the hand-removeable center console of FIGS. 5-10.

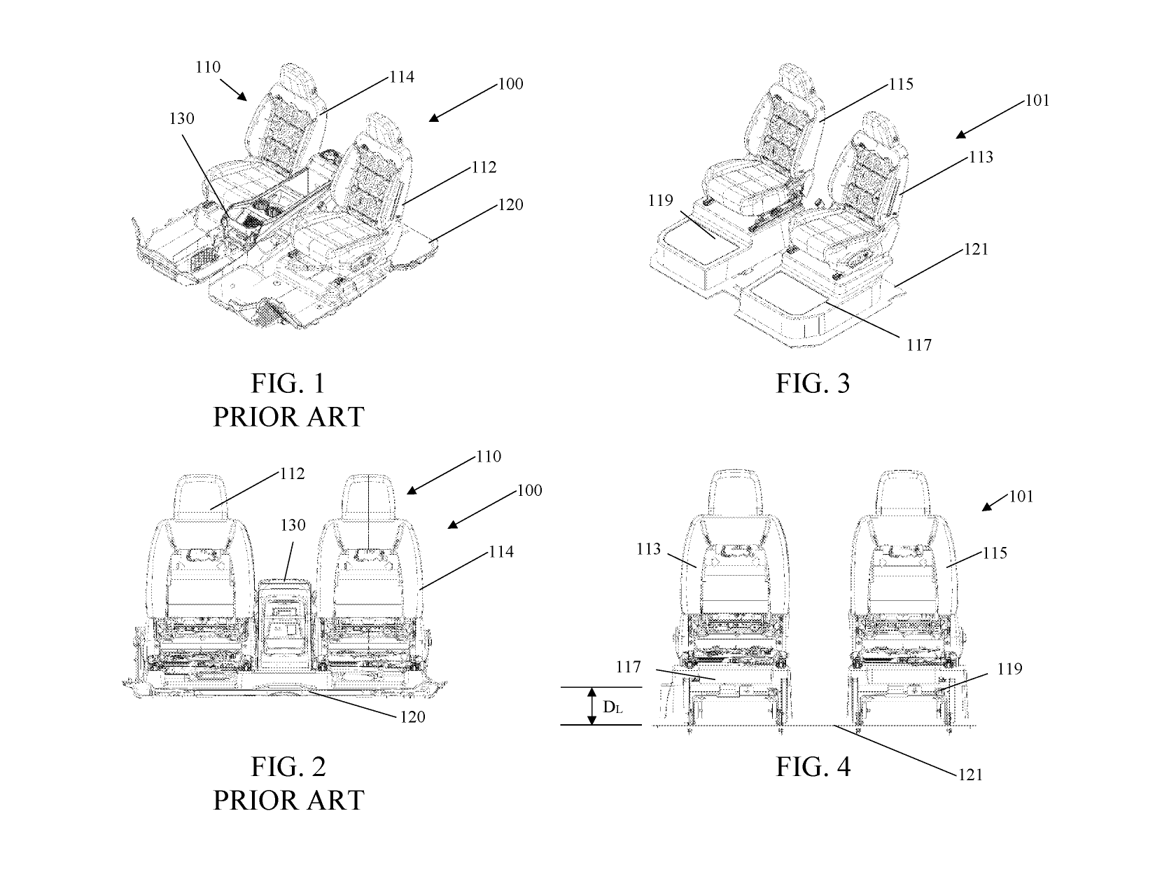

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

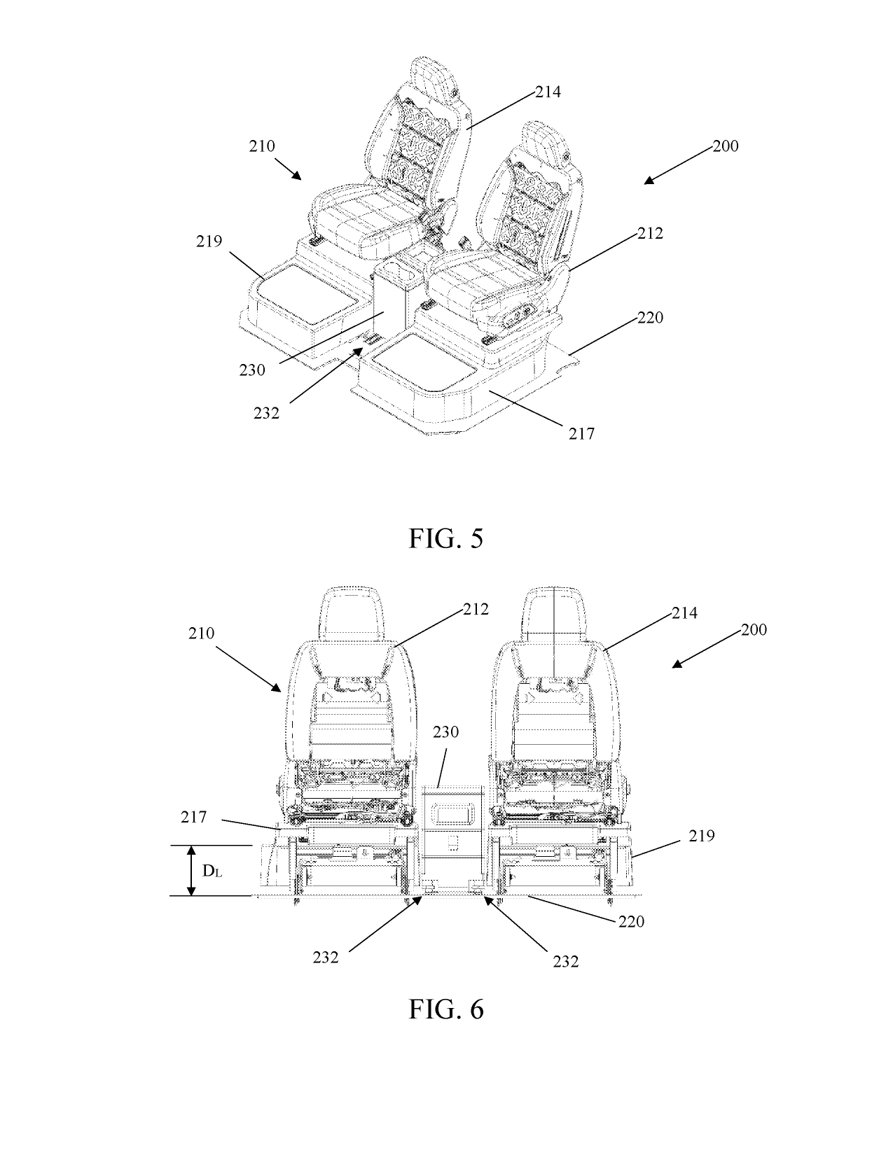

FIGS. 5-10 illustrate a front passenger compartment 210 of a passenger vehicle 200 that has been modified to include a lowered floor (or floor weldment) 220 for wheelchair accessibility. The lowered floor 220 may be lowered a distance D_{L} relative to the OEM floor 120. With specific reference to FIG. 5, the front passenger compartment 210 may be configured with a front passenger arrangement for ambulatory passenger seating. In particular, the front passenger arrangement may comprise a driver seat 212, a front passenger seat 214, and a center console 230. The driver seat 212 may be disposed in a driver position and include a seat base 217 that removably secures the driver seat 212 to the lowered floor 220. Similarly, the front passenger seat 214 may be disposed in a front passenger position and include a seat base 217 that removably secures the front passenger seat 214 to the lowered floor 220. The seat bases 217, 219 may define a riser to account for the lowered floor 230. The center console 230 may be centrally located between the front seats 212, 214 and may be secured in the front passenger compartment 210 by one or more fastening system 232. The fastening system 232 may be configured whereby the center console 230, like the front seats 212, 214, may be removeable from vehicle 200 by hand, without the use of tools, to free up one or both of the front passenger positions for use by a wheelchaired passenger. As shown in FIGS. 5-9, the center console 230 may be configured to be hand-removably secured to the lowered floor by the fastening system 232. In other embodiments, not shown, the center console 230 may be hand-removably secured to another structure in the vehicle by the fastening system 232, such as the dashboard and/or one or both of the front seats 212, 214.

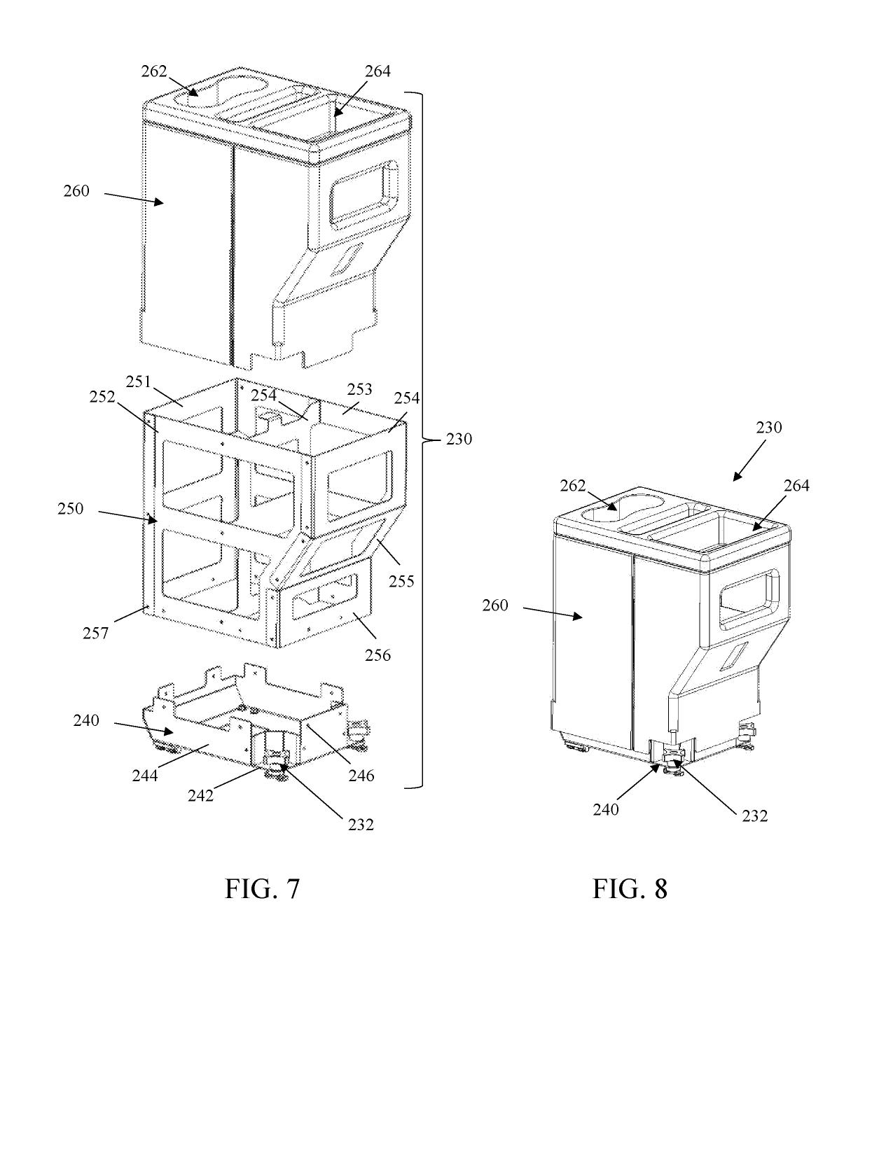

Referring now primarily to FIGS. 7-8, the center console 230 may define an assembly comprising a mounting frame 240, a support structure 250, and a cover 260. The mounting frame 240 may comprise a metal or plastic frame that may hold, receive, or engage with one or more components of the fastening system 232 for securing/mounting the center console 230 in the vehicle 200. As shown, the mounting frame 240 may comprise a metal sheet that has been formed (e.g., cut and bent) to include a bottom wall 242 and one or more side walls 244. Holes/apertures 246 may be formed (e.g., drilled or punched) on any one or more of the bottom wall 242 and side walls 244 for receiving the fastening system 232 for securing the mounting frame 240 to the vehicle and/or for receiving fasteners for securing the mounting frame assembly 240 to the support structure 250 and/or cover 260 via corresponding/overlapping holes/apertures 256, in the support structure 250 and/or cover 260.

The support structure 250 may comprise a metal or plastic frame that engages with the mounting frame 240 and generally defines the boundaries of the center console 230. As shown, the support structure 250 may comprise a plurality of plastic molded side panels that may be connected together by fasteners inserted through overlapping holes/apertures 257.

The cover 260 may define a molded plastic, finished shell for the center console 230 that includes cupholders 262, storage bins 264, and other features typically seen in OEM vehicles, including armrests and stereo, air conditioning, and heated seat controls. The cover may comprise multiple molded plastic portions 266, 267, 268 that are connected together and/or to the support structure 250 and/or mounting frame 240 by snapping or via fasteners inserted through overlapping apertures, as previously described.

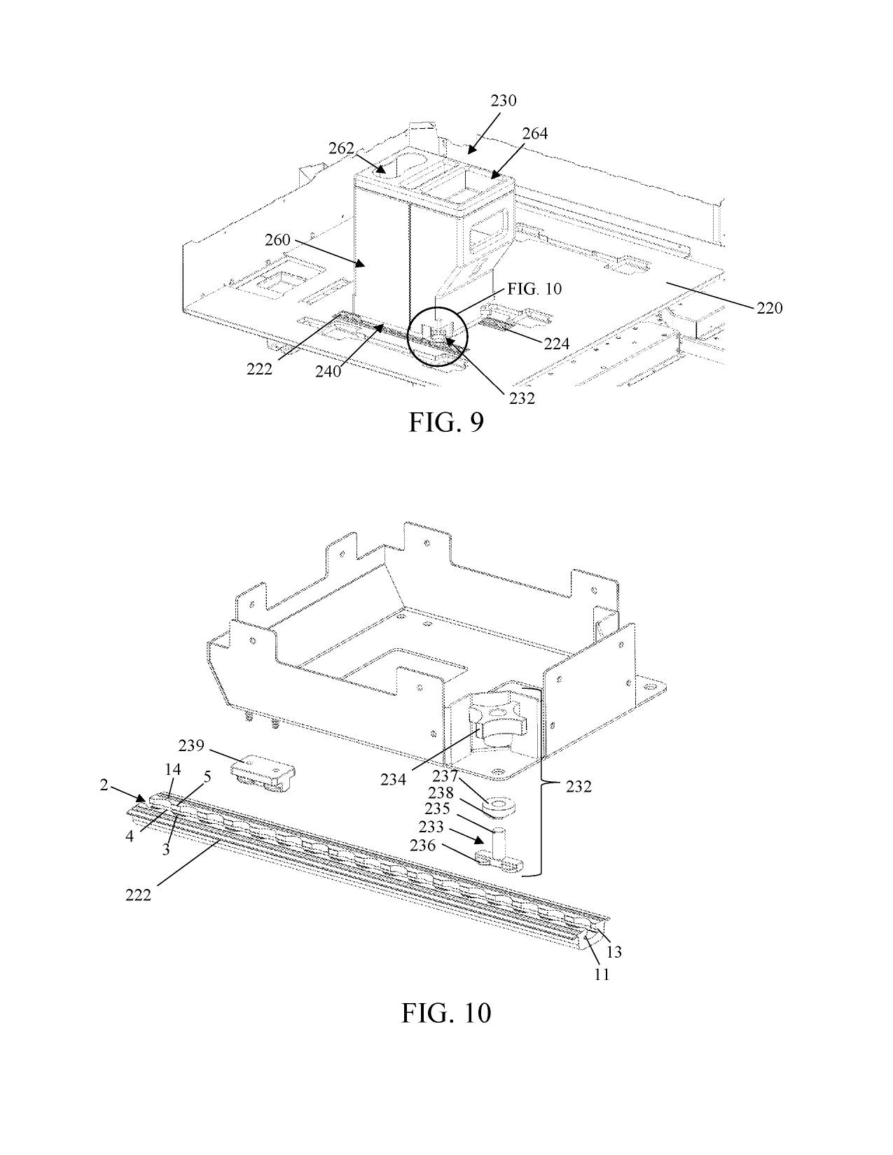

In one embodiment, the lowered floor 220 may comprise at least one track 222, 224 (or two as shown in FIGS. 5-10) disposed between the driver and front passenger positions for receiving and engaging with the fastening system 232 to hand-removably secure the center console 230 to the vehicle. The tracks permit flexible arrangement and easy installation and removal of the center console 230 anywhere along the length of the tracks. With particular reference to FIGS. 9-10, the tracks 222, 224 may be longitudinally aligned provided to allow the user to adjust the position of the center console 230 forward and rearward. In other embodiments, the tracks 222, 224 may be laterally-aligned to allow the user to adjust the position of the center console 230 rightward and leftward. In yet other embodiments, a grid of tracks may be provided to allow the user to adjust the position of the center console 230 both forward/rearward and side-to-side.

Each track 222, 224 may comprise L-type track. As known in the art, L-type track is generally formed from extruded aluminum in a generally C‐shape. With reference to FIG. 10, an open channel 2 extends lengthwise along the top surface of the track 222, 224 with undercuts 11, 13 extending under the top surface 14 of the track to either side of the open channel 2. A series of equally spaced holes 3 are drilled or formed along the length of the open channel 2 to define two opposing, scalloped, inwardly directed lips 4, 5.

The fastening system 232 may comprise one or more L-track fittings that are configured to hand-releasably engage with the tracks 222, 224. With particular reference to FIG. 10, which shows one of four fastening systems 232 used to secure the center console 230 to tracks 222, 224, the fastening system 232 comprises a fitting 233, a plunger 237, and a hand-tightening knob 234. The fitting 233 includes an upward extending threaded stud 235 configured to extend through an aperture in the mounting frame assembly 240 and engage with corresponding threads in the aperture of the hand tightening knob 234. The fitting 233 also includes a pair of laterally extending lobes 236 on each side configured to be lockingly received under the scalloped lips, while the plunger 237 includes at least one and as shown two circular or semi-circular downwardly extending projections 238 configured to be lockingly received in holes 3, as described hereinafter. To secure the fitting 233, and thus the center console 230 to the track 222, the fitting 236 may be dropped into the open channel 2 of the track 222 by aligning the lobes 236 though two adjacent holes 3 in the track. The plunger 237 may then be installed on top by the fitting 236 by inserted the stud 235 through the aperture of the plunger. Next, the center console 230 may be installed by inserting the stud 235 through the aperture of the center console 230. The knob 234 may then be loosely screwed on to of the stud 235. With the fitting 233 in the open channel 2 and the plunger 237 lifted slightly from the top surface 14 of the track 222, 224, the center console 230 can be slid along the length of the track to a desired location. To lock the center console 130 in place, the lobes 236 must be positioned under the scalloped lips, surrounding a hole 3, and the projection 238 of the plunger 237 must be dropped into the hole 3, where the lobes 236 and plunger 237 are secured by hand-tightening knob 234. Projections 238 prevent the center console 230 from sliding longitudinally down the length of track 222, 224, while lobes 236 prevent the center console 230 from lifting out of the track 222, 224.

In some embodiments, as shown, at least one or more of the fastening systems may omit a plunger, such as fastener 239.

In some embodiments, a second set of tracks may be provided in a second location in the vehicle, for instance in the rear cargo area of vehicle, where the center console 230 may be stored when not being used in the front passenger compartment.

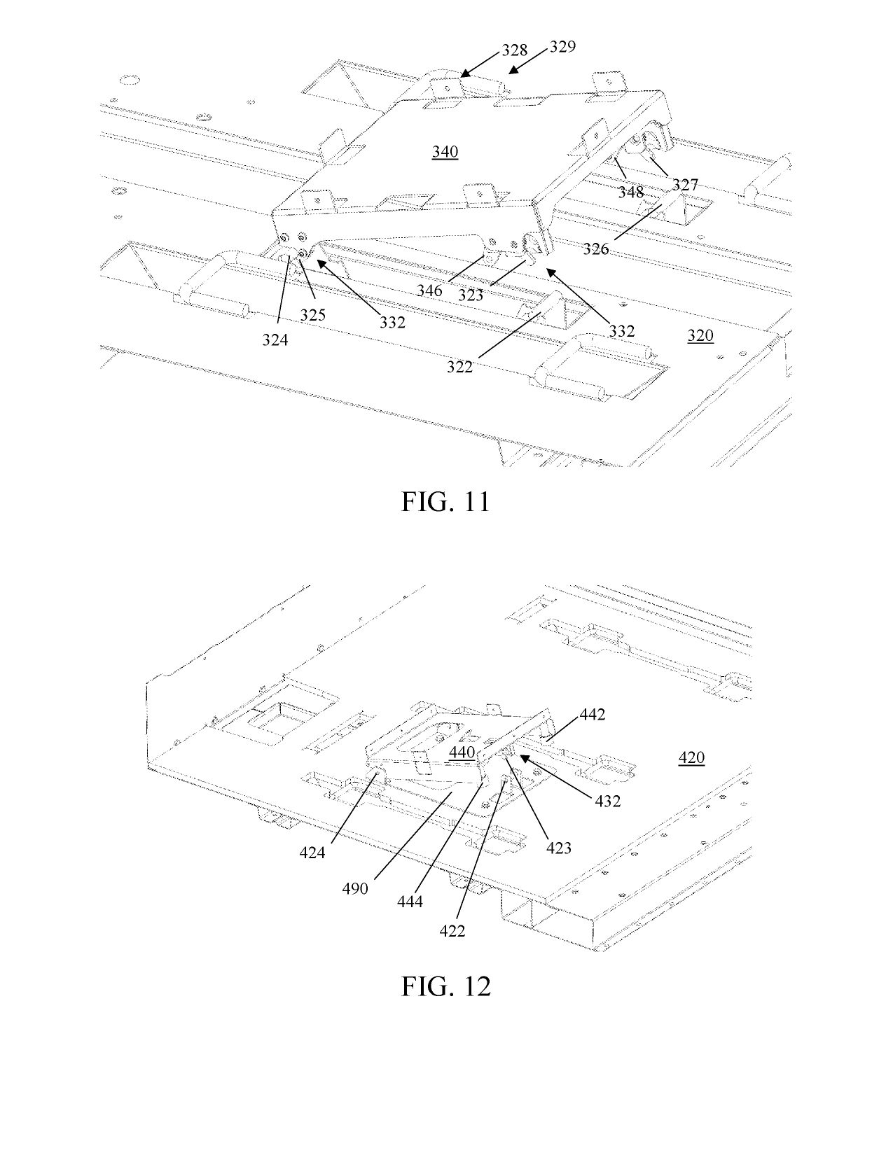

Referring now to FIG. 11, other means for securing the center console 230 are contemplated. For instance, the center console 230 may be provided with an alternative (second embodiment) mounting frame 340 configured to engage with an alternative lowered floor 320. More particularly, the lowered floor 320 may be provided with one or more (or as shown, four) integrated striker rods 322, 324, 326, 328 (328 being hidden) that are configured to engage with a corresponding fastening system 332 secured to the mounting frame 340. As shown, the fastening system 332 may comprise a pair of hooks 325, 329 (329 being hidden) that engage the front striker rods 324, 328 and a pair of rotary latches 323, 327 that engage the rear striker rods 322, 326. The hooks 325, 329 are configured to receive the front striker rods 324, 328 with the mount frame 340 (and thus the center console 230) in an inclined position shown in FIG. 11. Once the front striker rods 324, 328 are positioned within the hooks 325, 329, the center console 230 can be pivoted downward about an axis defined by the front striker rods 324, 328 until the rotary latches 323, 327 receive and lockingly engage the rear striker rods 322, 326. For removal, a cable system may be attached to the latch release pawls 346, 348 and activated by a pull handle mounted into the console 230.

Referring now to FIG. 12, the center console 230 may be provided with a third embodiment mounting frame 440 configured to engage with a console mounting plate 490 mounted on top of an alternative lowered floor 420 by bolts or other means of fastening. The console mounting plate 490 may be provided with one or more (or as shown, three) integrated striker rods 422, 424, 426 (426 being hidden) that are configured to engage with a corresponding fastening system 432 secured to the mounting frame 440. As shown, the fastening system 432 may comprise a pair of hooks 425, 429 (429 being hidden) that engage the front striker rods 424, 426 and a single rotary latch 423 that engages the rear striker rod 422. The hooks 425, 429 are configured to receive the front striker rods 424, 426 with the mounting frame 440 (and thus the center console 230) in an inclined position shown in FIG. 12. Once the front striker rods 424, 426 are positioned within the hooks 425, 429, the center console 230 can be pivoted downward about an axis defined by the front striker rods 424, 426 until the rotary latch 423 receives and lockingly engages the rear striker rod 422. The mounting frame 440 may include rubber bumpers 442, 444 that compress when contacting the mounting plate 490. The bumpers 442, 444 provide the center console 230 with lateral stability. For removal, a cable system may be attached to the latch 423 release pawl 446 (hidden) and activated by a pull handle mounted into the console 230.

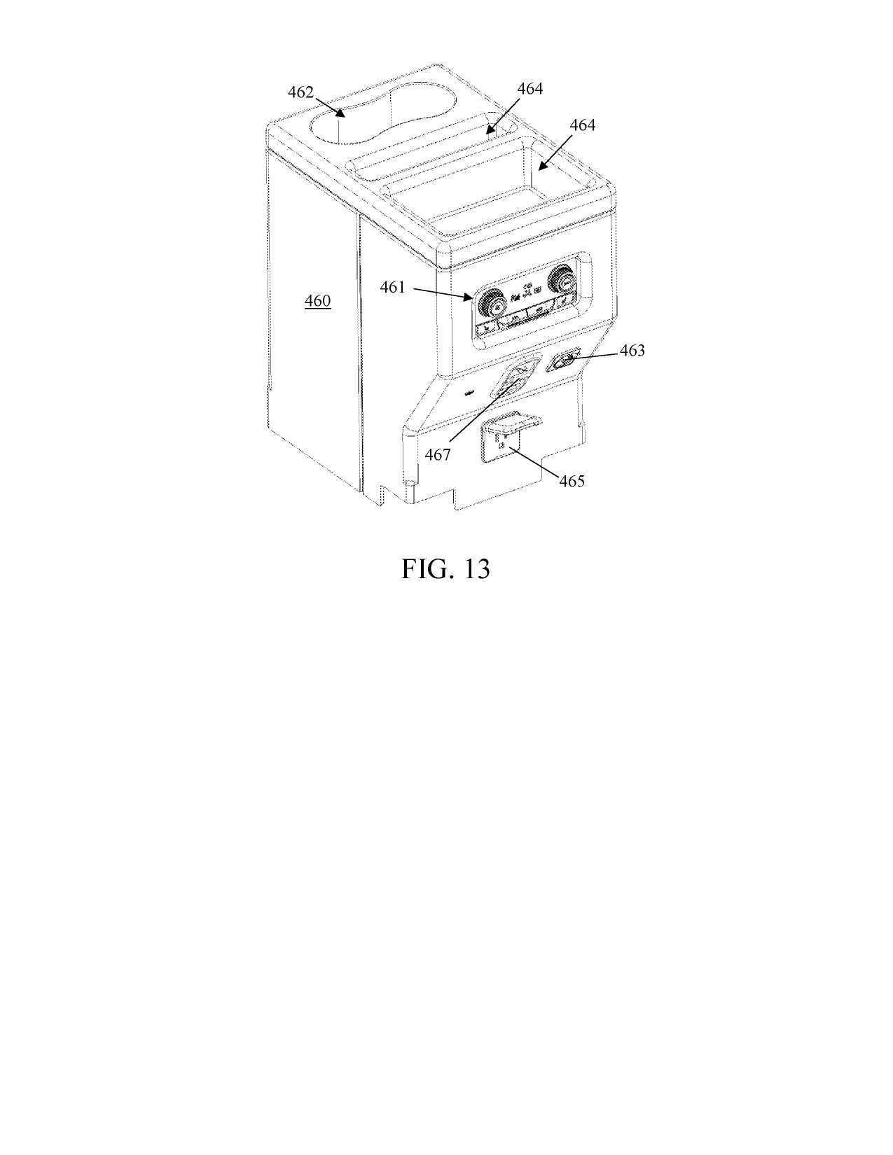

Regardless of what method of vehicle attachment is used, the center console 230 can contain a multitude of features or options, depending on the vehicle configuration. With particular reference to FIG. 13, showing a second embodiment of a cover 560, the center console 230 not only can be provided with cup holders 462 and storage bins 464, but also electrical controls 461, charging ports 463, and electrical outlets 465 can be installed when appropriate wire harnessing is adapted for a similar quick-release connection system. Similarly, a latch release pull handle 467 can be installed to disengage the previously mentioned latches 323, 327, 423.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for converting a passenger vehicle for wheelchair access, the method comprising the steps of:
removing a seating arrangement from the passenger vehicle, wherein the seating arrangement comprises at least one ambulatory seat and a console;
removing at least a portion of a floor of the passenger vehicle;
installing a lowered floor;
providing a replacement console with a hand-releasable connection member for connecting the replacement console to the lowered floor.

2. The method of claim 1, wherein the lowered floor installed in the passenger vehicle defines a front compartment area of the passenger vehicle.

3. The method of claim 2, wherein the lowered floor defines a driver position and a front passenger position and the hand-releasable connection is configured to connect the console to the lowered floor between the driver position and the front passenger position.

4. The method of claim 3, wherein the at least one ambulatory seat comprises a driver seat and a front passenger seat.

5. The method of claim 4, further comprising the step of providing the at least one ambulatory seat with a hand-releasable connection member for connecting the at least one ambulatory seat to the lowered floor.

6. The method of claim 5, further comprising the steps of modifying the driver seat to be hand-releasably connected to the lowered floor in the driver position and modifying the front passenger seat to be hand-releasably connected to the lowered floor in the front passenger position.

7. The method of claim 1, further comprising the step of providing the lowered floor with at least one track and wherein the hand-releasable connection member of the replacement console is a track fitting configured to lockingly engage the track.

8. The method of claim 7, wherein the at least one track comprises a set of two parallel tracks longitudinally aligned in the passenger vehicle, whereby the replacement console is adjustably mountable in a fore direction and an aft direction.

9. The method of claim 1, , further comprising the steps of providing the lowered floor with at least one striker bar and providing the replacement console with at least one rotary latch configured to lockingly engage the striker bar, wherein the at least one striker bar comprises a first striker bar and a second striker bar, further comprising the step of providing the replacement console with the rotary latch at a first end and with a hook at a second end, whereby the hook is configured to receive the first striker bar when the replacement console is in an inclined position and the rotary latch is configured to receive the second striker bar as the replacement console is pivoted downward from the inclined position.

10. The method of claim 1, further comprising the step of converting the console into the replacement console.

11. The method of claim 3, further comprising the steps of providing the lowered floor with a first corresponding connection member in a console use location and providing the passenger vehicle with a second corresponding connection member in a console stow location, wherein the first corresponding connection member and the second corresponding connection member are configured to engage with the hand-releasable connection member of the replacement console.

12. The method of claim 11 wherein the console use location is between the driver position and the front passenger position.

13. A passenger vehicle configured for wheelchair access, the passenger vehicle comprising:
a floor in a front compartment area of the vehicle;
a driver seat and a front passenger seat, each comprising a hand-releasable connection member connected the floor;
a console with a hand-releasable connection member connecting the console to the floor between the driver seat and the front passenger seat.

14. The passenger vehicle of claim 13 further comprising at least one track coupled to the floor, wherein the hand-releasable connection member of the console is a track fitting configured to lockingly engage the track.

15. The passenger vehicle of claim 14, wherein the at least one track comprises a set of two parallel tracks longitudinally aligned on the floor, whereby the console is adjustably mountable in a fore direction and an aft direction.

16. The passenger vehicle of claim 13 further comprising a first striker bar and a second striker bar coupled to the floor, wherein the console comprises a rotary latch at a first end and a hook at a second end, whereby the hook is configured to receive the first striker bar when the console is in an inclined position relative to the floor and the rotary latch is configured to receive the second striker bar as the console is pivoted downward from the inclined position.

17. The passenger vehicle of claim 13, wherein the console comprises an electronic control coupled to the passenger vehicle by a hand-releasable electric harness.

18. The passenger vehicle of claim 13, further comprising a first corresponding connection member coupled to the floor between the driver seat and the front passenger seat and a second corresponding connection member coupled to the passenger vehicle in a console stow location, wherein the first corresponding connection member and the second corresponding connection member are configured to engage with the hand-releasable connection member of the replacement console.

19. A method for using the vehicle of claim 13, the method comprising the step of configuring the vehicle to transport a first ambulatory passenger and a second ambulatory passenger by:
installing the driver seat in a driver position without using a tool;
installing the front passenger seat in a passenger position without using a tool;
installing the console between the driver seat and the front passenger seat without using a tool.

20. The method of claim 19 further comprising the step of configuring the vehicle to transport a wheelchaired passenger by:
removing at least one of the driver seat from a driver position and the front passenger seat from a front passenger position without using a tool;
removing the console without using a tool; and
securing the wheelchaired passenger in place of the at least one removed driver seat and passenger seat using a wheelchair securement system.
